(19) United States
(12) Patent Application Publication
(10) Pub. No.: US 2025/0167475 A1
(43) Pub. Date: May 22, 2025

(54) TERMINAL CONNECTION STRUCTURE

(71) Applicant: TOYOTA JIDOSHA KABUSHIKI KAISHA, Toyota-shi Aichi-ken (JP)

(72) Inventors: Hiroshi KAWANISHI, Nisshin-shi Aichi-ken (JP); Shingo NAGAI, Toyota-shi Aichi-ken (JP); Kengo OHIRA, Toyota-shi Aichi-ken (JP); Kenta KODAMA, Toyota-shi Aichi-ken (JP); Koichi KUWAHARA, Nagoya-shi Aichi-ken (JP); Shogo KAJIMOTO, Toyota-shi Aichi-ken (JP); Masashi IZUMI, Toyota-shi Aichi-ken (JP); Yuichiro KANADA, Toyota-shi Aichi-ken (JP); Takuya ISOMURA, Aichi-gun Aichi-ken (JP)

(73) Assignee: TOYOTA JIDOSHA KABUSHIKI KAISHA, Toyota-shi Aichi-ken (JP)

(21) Appl. No.: 18/946,054

(22) Filed: Nov. 13, 2024

(30) Foreign Application Priority Data
Nov. 20, 2023 (JP) 2023-196869

(51) Int. Cl. H01R 13/187

(52) U.S. Cl. CPC H01R 13/187

(57) ABSTRACT

A terminal connection structure includes a male terminal having a columnar shape; a female terminal having a hole to which the male terminal is inserted; a first contact member interposed between the male terminal and the female terminal and electrically connecting the male terminal to the female terminal; and a second contact member interposed between the male terminal and the female terminal and electrically connecting the male terminal to the female terminal.

### CROSS-REFERENCE TO RELATED APPLICATION

This application claims priority to Japanese Patent Application No. 2023-196869 filed on Nov. 20, 2023, incorporated herein by reference in its entirety.

### BACKGROUND

### 1. Technical Field

The disclosure of the specification relates to a terminal connection structure.

### 2. Description of Related Art

Japanese Unexamined Patent Application Publication No. 2019-008878 (JP 2019-008878 A) describes a terminal connection structure. The terminal connection structure includes a rod-shaped male terminal and a cylindrical female terminal. A contact member is provided between the male terminal and the female terminal and electrically connects the two terminals. The contact member is disposed between an outer face of the male terminal and an inner face of the female terminal and is configured to be elastically deformable in a radial direction.

### SUMMARY

The terminal connection structure is used in, for example, a motor circuit of an electrified vehicle. In this case, a relatively large current flows through the terminal connection structure. If a large current flows through the male terminal and the female terminal, a heat generation amount increases in the contact member that connects the two terminals. To reduce heat generation of the contact member, it is effective to increase a contact area of the contact member with the male terminal and the female terminal; however, the size of the male terminal and the size of the female terminal also increase accordingly, which may lead to an increase in the size of the terminal connection structure. The specification provides a technology for making it possible to reduce heat generation of a contact member without increasing the size of a terminal connection structure.

An aspect of the disclosure of the specification relates to a terminal connection structure. The terminal connection structure includes a male terminal having a columnar shape; a female terminal having a hole to which the male terminal is inserted; a first contact member interposed between the male terminal and the female terminal and electrically connecting the male terminal to the female terminal; and a second contact member interposed between the male terminal and the female terminal and electrically connecting the male terminal to the female terminal. The first contact member is disposed between an outer face of the male terminal and an inner face of the female terminal, the inner face facing the outer face. The first contact member is configured to elastically deform in a radial direction in which the outer face of the male terminal and the inner face of the female terminal face each other. The second contact member is disposed between a first face, other than the outer face, of the male terminal and a second face of the female terminal, the second face of the female terminal facing the first face of the male terminal. The second contact member is configured to elastically deform in a second direction in which the first face of the male terminal and the second face of the female terminal face each other.

According to the above aspect, it is possible to provide a wide contact area in which the two contact members contact with the male terminal and the female terminal as a whole. Thus, it is possible to reduce heat generation of the contact members without increasing the size of the terminal connection structure.

The first contact member may have a shape in which a plurality of elastic pieces each configured to elastically deform in the radial direction is arranged in a circumferential direction.

In the above aspect, the first contact member may have an upper end portion extending in the circumferential direction and a lower end portion extending in the circumferential direction, and the elastic pieces may extend between the upper end portion and the lower end portion.

In the above aspect, the first contact member may be in contact with the outer face of the male terminal at the upper end portion and the lower end portion, and may be in contact with the inner face of the female terminal at an intermediate part of each of the elastic pieces.

In the above aspect, the second contact member may have a shape in which a plurality of elastic pieces each configured to elastically deform in the radial direction is arranged in a circumferential direction.

In the above aspect, the second contact member may have a first end portion extending in the circumferential direction and a second end portion extending in the circumferential direction, and the elastic pieces may extend between the first end portion and the second end portion.

In the above aspect, the second contact member may be in contact with the first face of the male terminal at the first end portion and the second end portion, and may be in contact with the second face of the female terminal at an intermediate part of each of the of elastic pieces.

In the above aspect, the first contact member may extend along a circumferential direction and may have a first gap between first both ends of the first contact member in the circumferential direction. The second contact member may extend along the circumferential direction and may have a second gap between second both ends of the second contact member in the circumferential direction. A position of the first gap between the first both ends of the first contact member may be different from a position of the second gap between the second both ends of the second contact member in the circumferential direction.

In the above aspect, the female terminal may have a columnar portion provided upright from a bottom face of the female terminal. The male terminal may have a hole portion that receives the columnar portion of the female terminal. The second face of the female terminal may be an outer face of the columnar portion. The first face of the male terminal may be an inner face of the hole portion facing the outer face of the columnar portion.

In the above aspect, the terminal connection structure may further include a third contact member interposed between the male terminal and the female terminal. The third contact member may electrically connect the male terminal to the female terminal. The third contact member may be disposed between a distal end face of the male terminal and the bottom face of the female terminal, the bottom face of the female terminal facing the distal end face of the male terminal, and the third contact member may be configured to elastically deform in a third direction in which the distal end face of the male terminal and the bottom face of the female terminal face each other. The second direction may be the radial direction.

In the above aspect, the first contact member may be in contact with the inner face of the female terminal at the upper end portion and the lower end portion. The first contact member may be in contact with the outer face of the male terminal at an intermediate part of each of the elastic pieces.

In the above aspect, the third direction may be an axial direction parallel to an insertion direction of the male terminal to the female terminal.

In the above aspect, the first face of the male terminal may be a distal end face of the male terminal, and the second face of the female terminal may be a bottom face of the female terminal, the bottom face of the female terminal facing the distal end face of the male terminal.

In the above aspect, the second direction may be an axial direction parallel to an insertion direction of the male terminal to the female terminal.

In the above aspect, the second contact member may be in contact with the second face of the female terminal at the first end portion and the second end portion. The second contact member may be in contact with the first face of the male terminal at an intermediate part of each of the elastic pieces.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an end view that shows the configuration of a terminal connection structure;

FIG. 2 is an enlarged view of area II in FIG. 1;

FIG. 3 is a cross-sectional view of the terminal connection structure, taken along the line III-III in FIG. 1;

FIG. 4 is a perspective view of a first contact member;

FIG. 5 is a plan view of a third contact member;

FIG. 6 is an end view that shows the configuration of a terminal connection structure according to a first modification;

FIG. 7 is a plan view of a fourth contact member according to the first modification;

FIG. 8 is an end view that shows the configuration of a terminal connection structure according to a second modification;

FIG. 9 is an end view that shows the configuration of a terminal connection structure according to a third modification; and

FIG. 10 is an end view that shows the configuration of a terminal connection structure according to a fourth modification.

### DETAILED DESCRIPTION OF EMBODIMENTS

In a first configuration of the technology, a terminal connection structure may include a male terminal having a columnar shape, a female terminal having a hole to which the male terminal is inserted, and a first contact member and a second contact member interposed between the male terminal and the female terminal and electrically connecting the male terminal to the female terminal. The first contact member may be disposed between an outer face of the male terminal and an inner face of the female terminal, the inner face facing the outer face. The first contact member may be configured to elastically deform in a radial direction in which the outer face of the male terminal and the inner face of the female terminal face each other. The second contact member may be disposed between a second face, other than the outer face, of the male terminal and a second face of the female terminal, the second face of the female terminal facing the second face of the male terminal. The second contact member may be configured to elastically deform in a second direction in which the second face of the male terminal and the second face of the female terminal face each other.

In a second configuration of the technology, in addition to the first configuration, the first contact member may have a shape in which a plurality of elastic pieces each configured to elastically deform in the radial direction is arranged in a circumferential direction. In this case, the plurality of elastic pieces may be provided over the entire length of the outer face in the circumferential direction or may be provided over a partial length of the outer face in the circumferential direction.

In a third configuration of the technology, in addition to the second configuration, the first contact member may have an upper end portion extending in the circumferential direction and a lower end portion extending in the circumferential direction. In this case, the plurality of clastic pieces may extend between the upper end portion and the lower end portion. With such a configuration, the rigidity of the first contact member is increased as a whole while the elasticity of each of the elastic pieces is maintained.

In a fourth configuration of the technology, in addition to the third configuration, the first contact member may contact with one of the outer face of the male terminal and the inner face of the female terminal at the upper end portion and the lower end portion. The first contact member may be in contact with the other one of the outer face of the male terminal and the inner face of the female terminal at an intermediate part of each of the plurality of elastic pieces. With such a configuration, the first contact member is stably held between the male terminal and the female terminal. In addition, each of the plurality of elastic pieces functions as a leaf spring supported at both ends and can stably exercise its elasticity.

In a fifth configuration of the technology, in addition to any one of the first configuration to the fourth configuration, the second contact member may have a shape in which a plurality of elastic pieces each configured to elastically deform in the radial direction is arranged in a circumferential direction. In this case, the plurality of elastic pieces may be provided over the entire length of the second face in the circumferential direction or may be provided over a partial length of the second face in the circumferential direction.

In a sixth configuration of the technology, in addition to the fifth configuration, the second contact member may have a first end portion extending in the circumferential direction and a second end portion extending in the circumferential direction. In this case, the plurality of elastic pieces may extend between the first end portion and the second end portion. With such a configuration, the rigidity of the second contact member is increased as a whole while the elasticity of each of the elastic pieces is maintained.

In a seventh configuration of the technology, in addition to the sixth configuration, the second contact member may be in contact with one of the second face of the male terminal and the second face of the female terminal at the first end portion and the second end portion. The second contact member may be in contact with the other one of the second face of the male terminal and the second face of the female terminal at an intermediate part of each of the plurality of elastic pieces. With such a configuration, the second contact member is stably held between the male terminal and the female terminal. Each of the plurality of elastic pieces functions as a leaf spring supported at both ends and can stably exercise its elasticity.

In an eighth configuration of the technology, in addition to any one of the first configuration to the seventh configuration, the first contact member may extend along a circumferential direction and may have a gap between both ends in the circumferential direction. Similarly, the second contact member may extend along the circumferential direction and may have a gap between both ends in the circumferential direction. In this case, the gap between both ends of the first contact member and the gap between both ends of the second contact member may be different in position in the circumferential direction from each other. With such a configuration, the first contact member and the second contact member are disposed without any bias in the circumferential direction as a whole.

In a ninth configuration of the technology, in addition to any one of the first configuration to the eighth configuration, the female terminal may have a columnar portion provided upright from a bottom face of the female terminal. The male terminal may have a hole that receives the columnar portion of the female terminal. In this case, the second face of the female terminal may be an outer face of the columnar portion, and the second face of the male terminal may be an inner face of the hole, the inner face of the hole facing the outer face of the columnar portion. With such a configuration, it is possible to provide a wide contact area in which the second contact member contacts with the male terminal and the female terminal by providing the wide second face of the male terminal and the wide second face of the female terminal, facing each other.

In a tenth configuration of the technology, in addition to the ninth configuration, the second direction may be the radial direction. In another configuration, the second direction may be a direction that forms an angle with the radial direction.

In an eleventh configuration of the technology, in addition to the ninth configuration or the tenth configuration, the terminal connection structure may further include a third contact member interposed between the male terminal and the female terminal and electrically connecting the male terminal to the female terminal. In this case, the third contact member may be disposed between a distal end face of the male terminal and a bottom face of the female terminal, the bottom face of the female terminal facing the distal end face of the male terminal, and may be configured to elastically deform in a third direction in which the distal end face of the male terminal and the bottom face of the female terminal face each other. With such a configuration, the first contact member (and the second contact member) is interposed between the male terminal and the female terminal in the radial direction, and the third contact member is interposed between the male terminal and the female terminal in a direction different from the radial direction. Thus, even when there occur vibrations between the male terminal and the female terminal, contact between the male terminal and the female terminal is maintained by those contact members regardless of the direction of the vibrations.

In a twelfth configuration of the technology, in addition to the eleventh configuration, the third direction may be an axial direction parallel to an insertion direction of the male terminal to the female terminal. In another configuration, the third direction may be a direction that forms an angle with the axial direction.

In a thirteenth configuration of the technology, in addition to any one of the first configuration to the eighth configuration, the second face of the male terminal may be a distal end face of the male terminal. In this case, the second face of the female terminal may be a bottom face of the female terminal, the bottom face of the female terminal facing the distal end face of the male terminal. With such a configuration, the first contact member is interposed between the male terminal and the female terminal in the radial direction, and the second contact member is interposed between the male terminal and the female terminal in a direction different from the radial direction. Thus, even when there occur vibrations between the male terminal and the female terminal, contact between the male terminal and the female terminal is maintained by those contact members regardless of the direction of the vibrations.

In a fourteenth configuration of the technology, in addition to the thirteenth configuration, the second direction may be an axial direction parallel to an insertion direction of the male terminal to the female terminal. In another configuration, the second direction may be a direction that forms an angle with the axial direction.

Hereinafter, a typical and non-restrictive specific example of the present disclosure will be described in detail with reference to the attached drawings. The detailed description simply intends to show persons skilled in the art the details for carrying out an embodiment of the present disclosure and does not intend to limit the scope of the present disclosure. Additional features and disclosures described below may be used separately or together with the other features and disclosures in order to provide a further improved terminal connection structure.

Combinations of features and steps described in the following detailed description are not indispensable at the time of carrying out the disclosure in the broadest meaning and are described only in order to describe a particularly typical specific example. Furthermore, various features of the above and following typical specific example and various features of those described in the independent and dependent claims do not need to be combined as in the case of the specific example described here or as in the case of the order listed in order to provide additional and useful embodiments of the disclosure.

All the features described in the specification and/or the appended claims are intended to be individually and independently described as limitations on the disclosure at the time of filing and matters claimed, different from the configuration of features described in the embodiment and/or the claims. Furthermore, a description on all the numeric ranges and groups is intended to describe intermediate configurations of them as limitations on the disclosure at the time of filing and matters claimed.

### EMBODIMENT

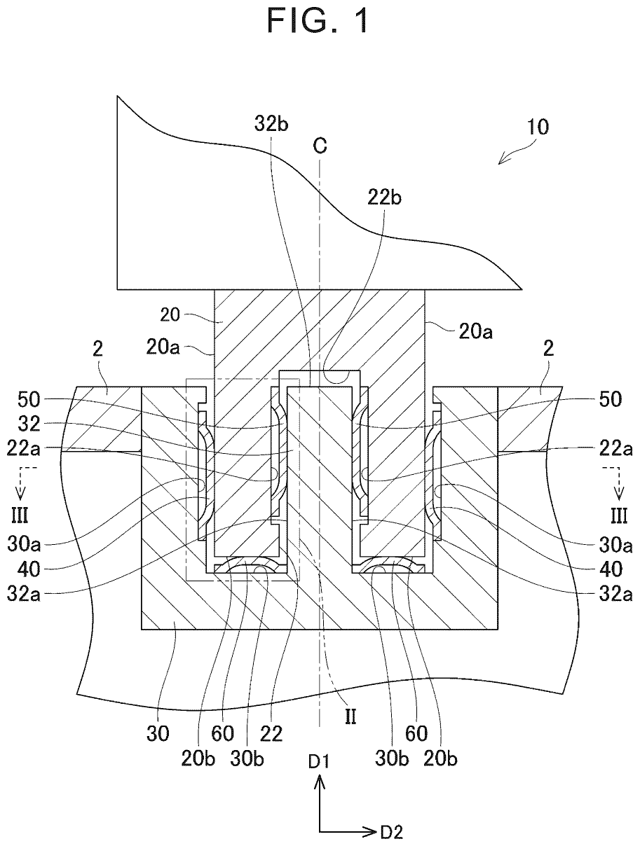

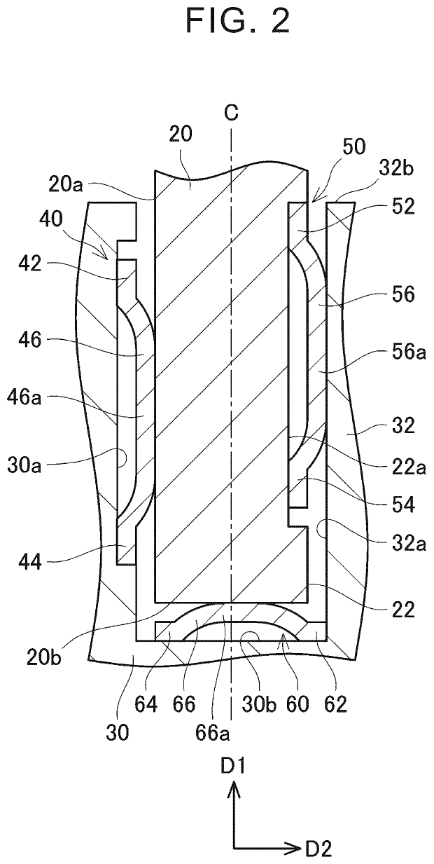

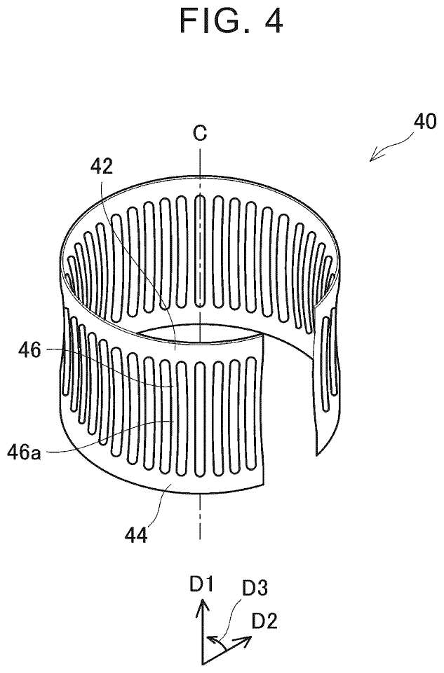

A terminal connection structure 10 according to an embodiment will be described with reference to FIG. 1 to FIG. 5. The terminal connection structure 10 may be used in a motor circuit of an electrified vehicle. As shown in FIG. 1 to FIG. 3, the terminal connection structure 10 includes a male terminal 20, a female terminal 30, a first contact member 40, a second contact member 50, and a third contact member 60. In an example, the male terminal 20 is an output terminal provided on an inverter side, and the female terminal 30 is an input terminal provided on a motor side of the electrified vehicle. The female terminal 30 is connected to a busbar 2 of the motor. In an example, the motor is driven by three-phase alternating-current power. The terminal connection structure 10 according to the present embodiment has at least three male terminals 20 and three female terminals 30 for U phase, V phase, and W phase. The terminal connection structure 10 may further has a fourth male terminal 20 and a fourth female terminal 30 for connecting a power converter to a neutral point in order to use the motor as a step-up/step-down circuit (so-called neutral point charge) at the time of charging the electrified vehicle. One or some or all of the components according to the technology may be applied to all the three pairs of terminals 20, 30 or all the four pairs of terminals 20, 30 or may be applied to at least one terminal pair 20, 30 of them. Each of the first contact member 40, the second contact member 50, and the third contact member 60 is interposed between the male terminal 20 and the female terminal 30 and electrically connects the male terminal 20 to the female terminal 30.

The male terminal 20 is roughly a columnar member. The male terminal 20 is made from a metal. A metal material used to make the male terminal 20 is, for example, copper. In a modification, the metal material used to make the male terminal 20 may be aluminum. The male terminal 20 has an outer face 20a and a distal end face 20b located at the distal end of the male terminal 20. The male terminal 20 has a hole (hole portion) 22 that is open at the distal end face 20b. The hole 22 has an inner face 22a and a bottom face 22b. The inner face 22a of the hole 22 extends between the distal end face 20b and the bottom face 22b of the male terminal 20. In other words, the male terminal 20 is a columnar member having an annular cross section.

The female terminal 30 has a hole, and the male terminal 20 is inserted into the hole. The female terminal 30 detachably receives the male terminal 20. The female terminal 30 is made from a metal. A metal material used to make the female terminal 30 is, for example, copper. In a modification, a material used to make the female terminal 30 may be aluminum. The female terminal 30 has an inner face 30a facing the outer face 20a of the male terminal 20 and a bottom face 30b facing the distal end face 20b of the male terminal 20. The female terminal 30 has a columnar portion 32 provided upright from the bottom face 30b. The columnar portion 32 can be inserted to and removed from the hole 22 of the male terminal 20 and is formed so as to be received by the hole 22 of the male terminal 20. The columnar portion 32 has an outer face 32a and a distal end face 32b located at the distal end of the columnar portion 32. The outer face 32a of the columnar portion 32 of the female terminal 30 faces the inner face 22a of the hole 22 of the male terminal 20. The distal end face 32b of the columnar portion 32 of the female terminal 30 faces the bottom face 22b of the hole 22 of the male terminal 20. In other words, the hole of the female terminal 30 has an annular cross section in correspondence with the cross-sectional shape of the male terminal 20.

In the specification, a cylindrical coordinate system composed of an axial direction D1, a radial direction D2, and a circumferential direction D3 is defined with reference to the male terminal 20 having a columnar shape. The axial direction D1 is a direction parallel to a longitudinal direction of the male terminal 20 having a columnar shape, and its coordinate axis is defined along a central axis C of the male terminal 20. The axial direction D1 coincides with an insertion direction of the male terminal 20 to the female terminal 30. The radial direction D2 is a direction perpendicular to the axial direction D1 and is defined as a coordinate axis having an origin at the central axis C of the male terminal 20. Then, the circumferential direction D3 is a direction perpendicular to the axial direction D1 and the radial direction D2 and is defined as a coordinate axis that orbits around the central axis C of the male terminal 20.

As shown in FIG. 1 to FIG. 4, the first contact member 40 is interposed between the male terminal 20 and the female terminal 30 in the radial direction D2. The first contact member 40 is disposed between the outer face 20a of the male terminal 20 and the inner face 30a of the female terminal 30.

The first contact member 40 is roughly a cylindrical sheet member and extends along the circumferential direction D3. The first contact member 40 has a first upper end portion 42, a first lower end portion 44, and a plurality of first elastic pieces 46. The first upper end portion 42 is located at the upper end of the first contact member 40 and extends in the circumferential direction D3. The first lower end portion 44 is located at the lower end of the first contact member 40 and extends in the circumferential direction D3.

Each of the first elastic pieces 46 is configured to be capable of elastically deforming along the radial direction D2. Each of the first elastic pieces 46 extends between the first upper end portion 42 and the first lower end portion 44. In other words, the first clastic pieces 46 are coupled to one another by the first upper end portion 42 and the first lower end portion 44 at both ends thereof. With such a configuration, the rigidity of the first contact member 40 is increased as a whole while the elasticity of each of the first elastic pieces 46 is maintained.

The first contact member 40 has a shape in which the first elastic pieces 46 are arranged in the circumferential direction D3. The first clastic pieces 46 are provided over substantially the entire length on the outer face 20a of the male terminal 20. In the specification, the term “substantially the entire length” indicates a length greater than or equal to about 70% of the entire length of the outer face 20a of the male terminal 20 in the circumferential direction D3. However, the first clastic pieces 46 are not limited thereto. The first elastic pieces 46 may be provided over a partial length of the outer face 20a of the male terminal 20 in the circumferential direction D3.

The first contact member 40 contacts with the inner face 30a of the female terminal 30 at the first upper end portion 42 and the first lower end portion 44. Then, the first contact member 40 is in contact with the outer face 20a of the male terminal 20 at an intermediate part 46a of each of the first elastic pieces 46. In other words, the male terminal 20 is press-fitted into the female terminal 30, and the first contact member 40 is elastically deformed between the male terminal 20 and the female terminal 30. With such a configuration, the first contact member 40 is stably held between the male terminal 20 and the female terminal 30. In addition, each of the first elastic pieces 46 functions as a leaf spring supported at both ends and can stably exercise its elasticity. Although not limited, the inner face 30a of the female terminal 30 has a recess. The first upper end portion 42 and the first lower end portion 44 of the first contact member 40 engage with the recess of the inner face 30a of the female terminal 30.

As shown in FIG. 1 to FIG. 3, the second contact member 50 is interposed between the male terminal 20 and the female terminal 30 in the radial direction D2. The second contact member 50 is disposed between the inner face 22a of the hole 22 of the male terminal 20 and the outer face 32a of the columnar portion 32 of the female terminal 30.

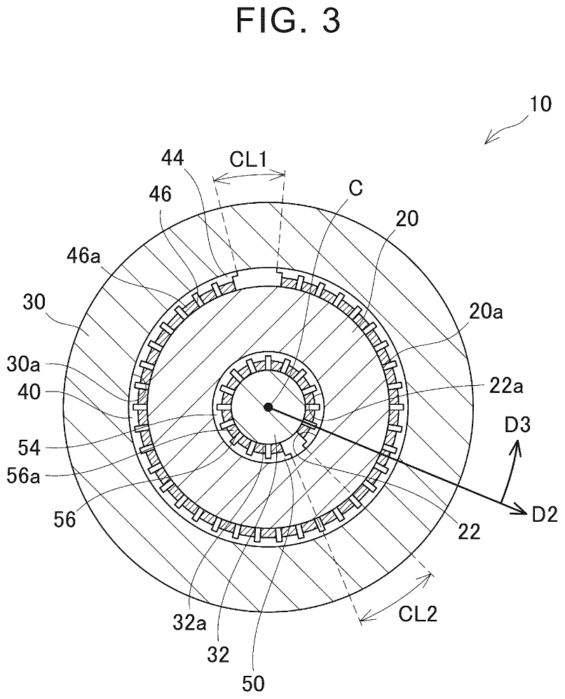

The second contact member 50 is roughly a cylindrical sheet member and extends along the circumferential direction D3. The second contact member 50 has a second upper end portion 52, a second lower end portion 54, and a plurality of second elastic pieces 56. The second upper end portion 52 is located at the upper end of the second contact member 50 and extends in the circumferential direction D3. The second lower end portion 54 is located at the lower end of the second contact member 50 and extends in the circumferential direction D3. In other words, the second contact member 50 differs from the first contact member 40 in size, but the second contact member 50 has a similar structure to the structure of the first contact member 40 shown in FIG. 3.

Each of the second elastic pieces 56 is configured to be capable of elastically deforming along the radial direction D2. Each of the second clastic pieces 56 extends between the second upper end portion 52 and the second lower end portion 54. In other words, the second elastic pieces 56 are coupled to one another by the second upper end portion 52 and the second lower end portion 54 at both ends thereof. With such a configuration, the rigidity of the second contact member 50 is increased as a whole while the elasticity of each of the second elastic pieces 56 is maintained.

The second contact member 50 contacts with the inner face 22a of the hole 22 of the male terminal 20 at the second upper end portion 52 and the second lower end portion 54. Then, the second contact member 50 is in contact with the outer face 32a of the columnar portion 32 of the female terminal 30 at an intermediate part 56a of each of the second elastic pieces 56. With such a configuration, the second contact member 50 is stably held between the male terminal 20 and the female terminal 30. In addition, each of the second elastic pieces 56 functions as a leaf spring supported at both ends and can stably exercise its elasticity. Although not limited, the inner face 22a of the hole 22 of the male terminal 20 has a recess. The second upper end portion 52 and the second lower end portion 54 of the second contact member 50 engage with the recess of the hole 22 of the male terminal 20.

The second contact member 50 has a shape in which the second elastic pieces 56 are arranged in the circumferential direction D3. In this case, the second elastic pieces 56 are provided over substantially the entire length of the outer face 32a of the columnar portion 32 of the female terminal 30 in the circumferential direction D3. However, the second elastic pieces 56 are not limited thereto. The second elastic pieces 56 may be provided over a partial length of the outer face 32a of the columnar portion 32 of the female terminal 30 in the circumferential direction D3.

As shown in FIG. 3, the first contact member 40 is provided with a gap CL1 between both ends of the first contact member 40 in the circumferential direction D3. Similarly to the first contact member 40, the second contact member 50 is provided with a gap CL2 between both ends of the second contact member 50 in the circumferential direction D3. The gap CL1 between both ends of the first contact member 40 and the gap CL2 between both ends of the second contact member 50 are different in position in the circumferential direction D3 from each other. With such a configuration, the first contact member 40 and the second contact member 50 are disposed without any bias in the circumferential direction D3 as a whole.

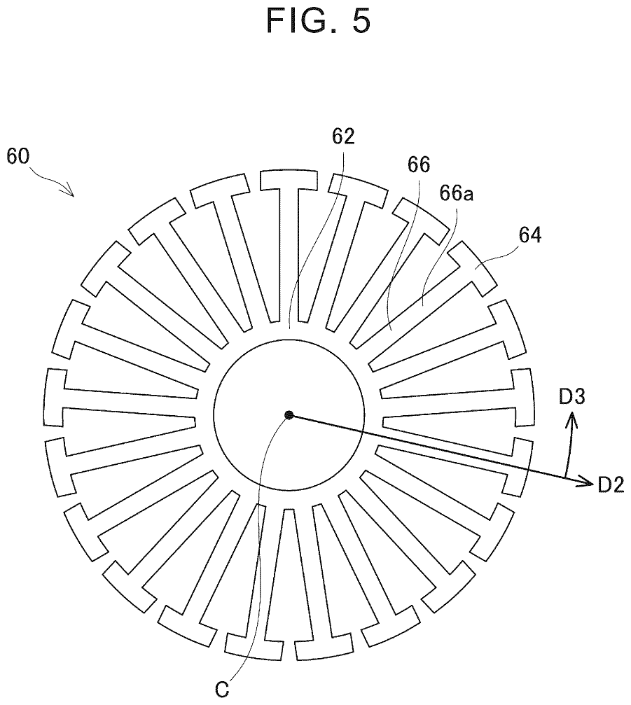

As shown in FIG. 1 to FIG. 3, and FIG. 5, the third contact member 60 is interposed between the male terminal 20 and the female terminal 30 in the axial direction D1. The third contact member 60 is disposed between the distal end face 20b of the male terminal 20 and the bottom face 30b of the female terminal 30. The third contact member 60 is configured to be capable of elastically deforming in the axial direction D1.

The third contact member 60 is roughly a disc-shaped sheet member. The third contact member 60 has an inner peripheral end 62, a plurality of outer peripheral ends 64, and a plurality of third elastic pieces 66. The third elastic pieces 66 extend between the inner peripheral end 62 and the outer peripheral ends 64. The inner peripheral end 62 is located at an inner peripheral end of the third contact member 60 and extends in the circumferential direction D3. The third contact member 60 is in contact with the outer face 20a of the male terminal 20 at an intermediate part 66a of each of the third elastic pieces 66 of the third contact member 60. The inner peripheral end 62 has an annular shape that rounds in the circumferential direction D3. The outer peripheral ends 64 are respectively located at the outer peripheral ends of the third elastic pieces 66 and intermittently extend along the circumferential direction D3. Each of the third elastic pieces 66 is configured to be capable of elastically deforming in the axial direction D1 between the inner peripheral end 62 and a corresponding one of the outer peripheral ends 64. The configuration is not limited to the above-described configuration. The outer peripheral end 64 may have an annular shape that rounds in the circumferential direction D3. In this case, the inner peripheral end 62 may be divided into a plurality of sections so as to intermittently extend along the circumferential direction D3.

In the terminal connection structure 10 according to the embodiment, the first contact member 40 and the second contact member 50 are provided between the male terminal 20 and the female terminal 30. The first contact member 40 is located between the outer face 20a of the male terminal 20 and the inner face 30a of the female terminal 30. The first contact member 40 contacts with both the male terminal 20 and the female terminal 30. In addition, the second contact member 50 is located between the inner face 22a of the hole 22, different from the outer face 20a, of the male terminal 20 and the outer face 32a of the columnar portion 32 of the female terminal 30, the outer face 32a of the columnar portion 32 facing the inner face 22a of the hole 22. The second contact member 50 contacts with both the male terminal 20 and the female terminal 30. With such a configuration, it is possible to provide a wide contact area in which the two contact members 40, 50 contact with the male terminal 20 and the female terminal 30 as a whole. Thus, it is possible to reduce heat generation of the contact members 40, 50 without increasing the size of the terminal connection structure 10.

Particularly, the female terminal 30 according to the present embodiment has the columnar portion 32, and the male terminal 20 has the hole 22 that receives the columnar portion 32 of the female terminal 30. With this configuration, it is possible to effectively expand the region in which the male terminal 20 and the female terminal 30 face each other, and, by disposing the second contact member 50 in that region, it is possible to reduce electrical resistance between the male terminal 20 and the female terminal 30.

The first contact member 40 is provided in the gap between the outer face 20a of the male terminal 20 and the inner face 30a of the female terminal 30. On the other hand, the second contact member 50 is provided in the gap between the inner face 22a of the hole 22 of the male terminal 20 and the outer face 32a of the columnar portion 32 of the female terminal 30. The male terminal 20 and the female terminal 30 thermally deform (expand or contract) in these two gaps, and their sizes respectively change. Basically, as the gap increases, the contact area between the male terminal 20 or the female terminal 30 and the contact members 40, 50 reduces. In terms of this point, it is effective that the coefficient of linear expansion of the material used to make the male terminal 20 and the coefficient of linear expansion of the material used to make the female terminal 30 are different from each other. With such a configuration, when the male terminal 20 and the female terminal 30 thermally deform (expand or contract), one of the two gaps increases; whereas the other one of the two gaps reduces. Thus, even when the contact area with the male terminal 20 or the female terminal 30 reduces at one of the two contact members 40, 50, the contact area with the male terminal 20 or the female terminal 30 can be increased at the other one of the two contact members 40, 50.

Furthermore, the terminal connection structure 10 includes the third contact member 60 interposed between the male terminal 20 and the female terminal 30 in addition to the first contact member 40 and the second contact member 50. With such a configuration, it is possible to provide a further wide contact area in which the three contact members 40, 50, 60 contact with the male terminal 20 and the female terminal 30 as a whole.

In addition, the first contact member 40 and the second contact member 50 are interposed between the male terminal 20 and the female terminal 30 in the radial direction D2; whereas the third contact member 60 is interposed between the male terminal 20 and the female terminal 30 in the axial direction D1 different from the radial direction D2. Thus, even when there occur vibrations between the male terminal 20 and the female terminal 30, contact between the male terminal 20 and the female terminal 30 is maintained by those contact members 40, 50, 60 regardless of the direction of the vibrations.

Here, the radial direction D2 is an example of the “second direction”. The inner face 22a of the hole 22 of the male terminal 20 is an example of the “second face of the male terminal”. The outer face 32a of the columnar portion 32 of the female terminal 30 is an example of the “second face of the female terminal”. The axial direction D1 is an example of the “third direction”. The number of contact members interposed between the male terminal 20 and the female terminal 30 is not limited to three and may be two or more as will be described in modifications later.

### First Modification

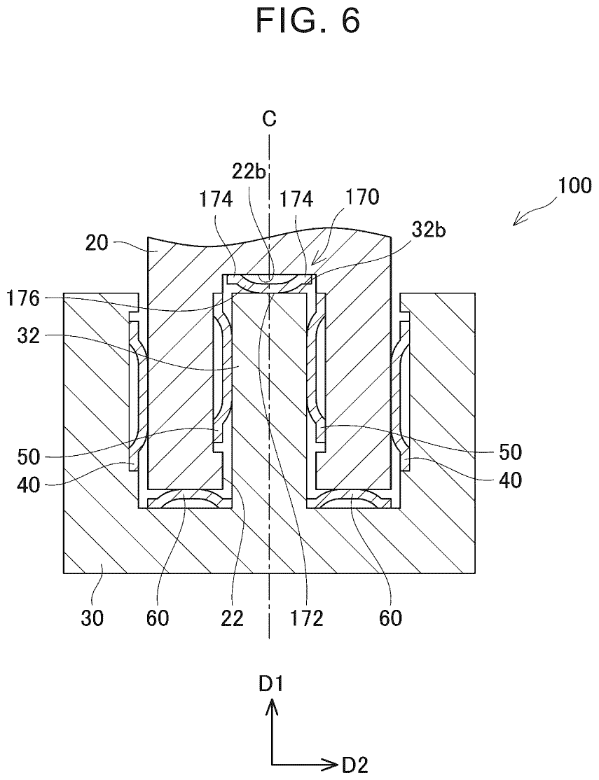

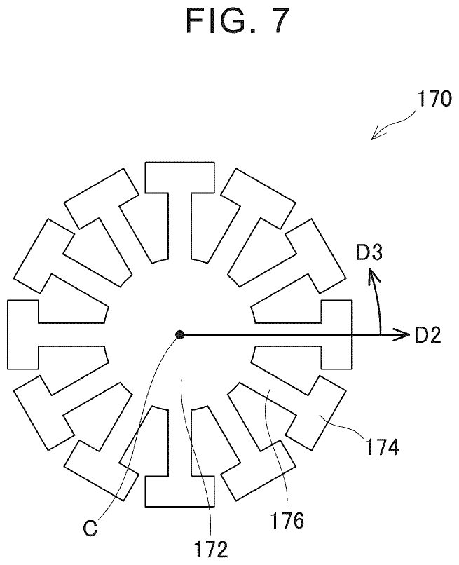

A terminal connection structure 100 according to a first modification will be described with reference to FIG. 6 and FIG. 7. As shown in FIG. 6, the terminal connection structure 100 may further include a fourth contact member 170 in addition to the three contact members 40, 50, 60 of the terminal connection structure 10 according to the embodiment. The fourth contact member 170 may be interposed between the male terminal 20 and the female terminal 30 in the axial direction D1. In this case, the fourth contact member 170 may be disposed between the bottom face 22b of the hole 22 of the male terminal 20 and the distal end face 32b of the columnar portion 32 of the female terminal 30. Then, the fourth contact member 170 may be configured to be capable of elastically deforming in the axial direction D1. With such a configuration, it is possible to provide a further wide contact area in which the four contact members 40, 50, 60, 170 contact with the male terminal 20 and the female terminal 30 as a whole.

As shown in FIG. 7, the fourth contact member 170 may have a central part 172, a plurality of outer peripheral ends 174, and a plurality of fourth elastic pieces 176. The fourth elastic pieces 176 extend between the central part 172 and the outer peripheral ends 174. The central part 172 may be located at the center of the fourth contact member 170. The central part 172 may have a circular shape. The outer peripheral ends 174 may be located at the outer peripheral end of the fourth contact member 70 and may intermittently extend along the circumferential direction D3. Each of the fourth elastic pieces 176 may be configured to be capable of elastically deforming in the axial direction D1 between the central part 172 and a corresponding one of the outer peripheral ends 174. The fourth contact member 170 may be in contact with the bottom face 22b of the hole 22 of the male terminal 20 at the outer peripheral ends 174 and may be in contact with the distal end face 32b of the columnar portion 32 of the female terminal 30 at the central part 172. In the first modification, the terminal connection structure 100 may include only the first contact member 40 and the fourth contact member 170 and does not need to include the second contact member 50 or the third contact member 60. In this case, the axial direction D1 corresponds to an example of the “second direction” in the technology. The bottom face 22b of the hole 22 of the male terminal 20 corresponds to an example of the “second face of the male terminal”. Then, the distal end face 32b of the columnar portion 32 of the female terminal 30 corresponds to an example of the “second face of the female terminal”.

### Second Modification

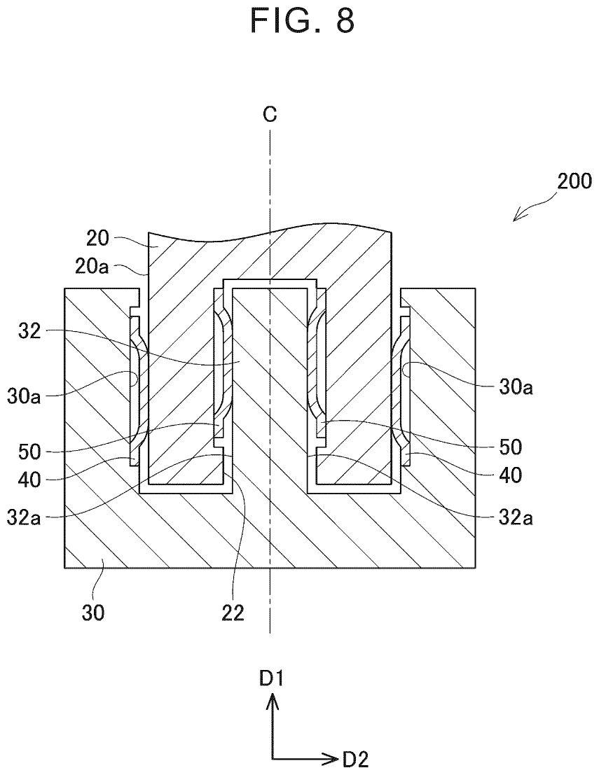

A terminal connection structure 200 according to a second modification will be described with reference to FIG. 8. As shown in FIG. 8, the terminal connection structure 200 may include only the two contact members 40, 50. The two contact members 40, 50 may be the first contact member 40 and the second contact member 50 interposed between the male terminal 20 and the female terminal 30 in the radial direction D2.

### Third Modification

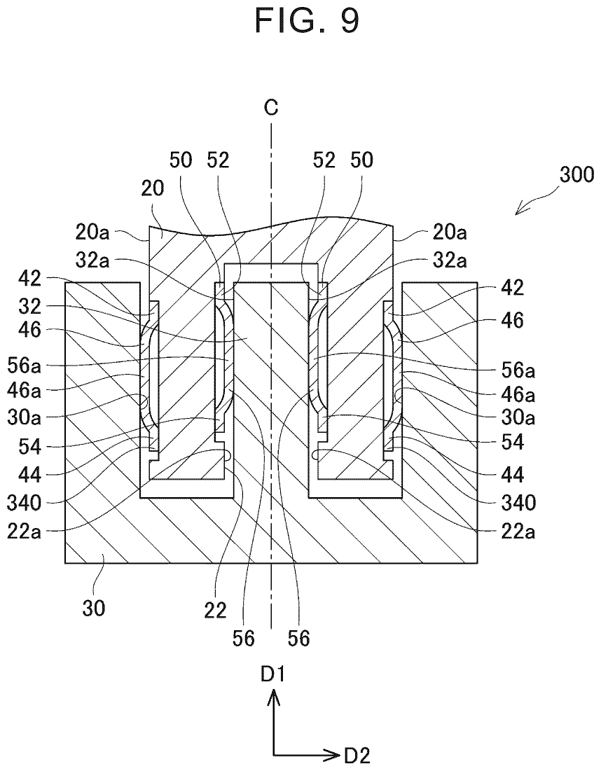

A terminal connection structure 300 according to a third modification will be described with reference to FIG. 9. As shown in FIG. 9, a first contact member 340 of the terminal connection structure 300 may be configured such that a positional relationship in the radial direction D2 between both the first upper end portion 42 and the first lower end portion 44 and the intermediate part 46a of each of the first elastic pieces 46 is inverted from that of the first contact member 40 according to the embodiment. In other words, the first contact member 340 may be in contact with the outer face 20a of the male terminal 20 at the first upper end portion 42 and the first lower end portion 44 and may be in contact with the inner face 30a of the female terminal 30 at the intermediate part 46a of each of the first clastic pieces 46. With such a configuration, the rigidity of the first contact member 340 is increased as a whole while the elasticity of each of the first elastic pieces 46 is maintained. In another modification, a second contact member may be configured such that a positional relationship in the radial direction D2 between both the second upper end portion 52 and the second lower end portion 54 and the intermediate part 56a of each of the second elastic pieces 56 is inverted from that of the second contact member 50 according to the embodiment. In other words, in this case, the second contact member may be in contact with the outer face 32a of the columnar portion 32 of the female terminal 30 at the second upper end portion 52 and the second lower end portion 54 and may be in contact with the inner face 22a of the hole 22 of the male terminal 20 at the intermediate part 56a of each of the second elastic pieces 56.

### Fourth Modification

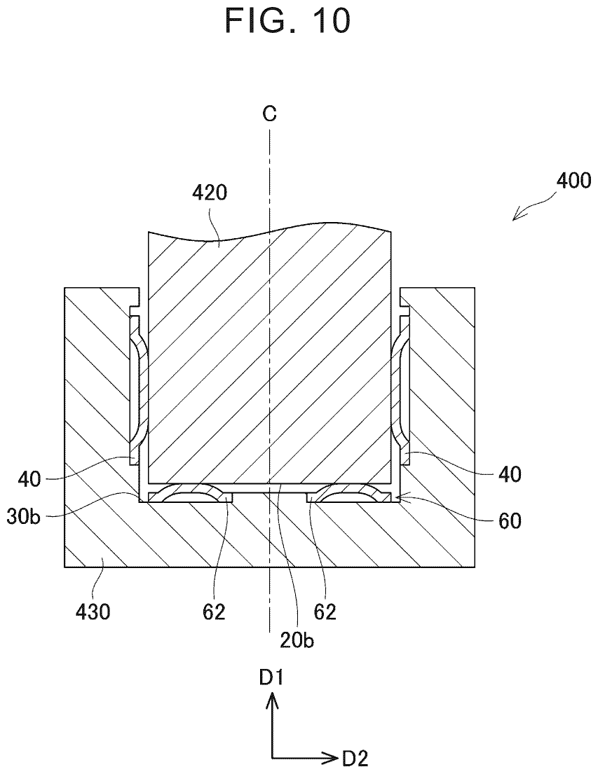

A terminal connection structure 400 according to a fourth modification will be described with reference to FIG. 10. As shown in FIG. 10, the terminal connection structure 400 may include a male terminal 420, a female terminal 430, the first contact member 40, and the third contact member 60. The male terminal 420 does not need to have a hole that is open at the distal end face 20b. The female terminal 430 does not need to have a columnar portion provided upright from the bottom face 30b. With such a configuration, the first contact member 40 is interposed between the male terminal 420 and the female terminal 430 in the radial direction D2, and the third contact member 60 is interposed between the male terminal 420 and the female terminal 430 in the axial direction D1 different from the radial direction D2. Thus, even when there occur vibrations between the male terminal 420 and the female terminal 430, contact between the male terminal 420 and the female terminal 430 is maintained by those contact members 40, 60 regardless of the direction of the vibrations. In this case, the inner peripheral end 62 of the third contact member 60 does not need to have an annular shape and may have a circular shape with no hole. Thus, it is possible to provide a further wide contact area in which the third contact member 60 contacts with the male terminal 20 and the female terminal 30.

Here, the axial direction D1 is an example of the “second direction”. The distal end face 20b of the male terminal 420 is an example of the “second face of the male terminal”. The bottom face 30b of the female terminal 430 is an example of the “second face of the female terminal”.

In the present embodiment, the male terminal 20 is a columnar member having an annular cross section; however, the configuration is not limited thereto. The male terminal 20 may be a columnar member having a polygonal annular cross section. The hole of the female terminal 30 is also not limited to the configuration of the embodiment, and does not need to have an annular cross section. The shape of the hole of the female terminal 30 may be modified as needed according to the male terminal 20.

What is claimed is:

1. A terminal connection structure comprising:
a male terminal having a columnar shape;
a female terminal having a hole to which the male terminal is inserted;
a first contact member interposed between the male terminal and the female terminal and electrically connecting the male terminal to the female terminal; and
a second contact member interposed between the male terminal and the female terminal and electrically connecting the male terminal to the female terminal, wherein
the first contact member is disposed between an outer face of the male terminal and an inner face of the female terminal, the inner face facing the outer face,
the first contact member is configured to elastically deform in a radial direction in which the outer face of the male terminal and the inner face of the female terminal face each other,
the second contact member is disposed between a first face, other than the outer face, of the male terminal and a second face of the female terminal, the second face of the female terminal facing the first face of the male terminal, and
the second contact member is configured to elastically deform in a second direction in which the first face of the male terminal and the second face of the female terminal face each other.

2. The terminal connection structure according to claim 1, wherein the first contact member has a shape in which a plurality of elastic pieces each configured to elastically deform in the radial direction is arranged in a circumferential direction.

3. The terminal connection structure according to claim 2, wherein:
the first contact member has an upper end portion extending in the circumferential direction and a lower end portion extending in the circumferential direction; and
the elastic pieces extend between the upper end portion and the lower end portion.

4. The terminal connection structure according to claim 3, wherein:
the first contact member is in contact with the outer face of the male terminal at the upper end portion and the lower end portion; and
the first contact member is in contact with the inner face of the female terminal at an intermediate part of each of the elastic pieces.

5. The terminal connection structure according to claim 1, wherein the second contact member has a shape in which a plurality of elastic pieces each configured to elastically deform in the radial direction is arranged in a circumferential direction.

6. The terminal connection structure according to claim 5, wherein:
the second contact member has a first end portion extending in the circumferential direction and a second end portion extending in the circumferential direction; and
the elastic pieces extend between the first end portion and the second end portion.

7. The terminal connection structure according to claim 6, wherein
the second contact member is in contact with the first face of the male terminal at the first end portion and the second end portion, and
the second contact member is in contact with the second face of the female terminal at an intermediate part of each of the elastic pieces.

8. The terminal connection structure according to claim 1, wherein:
the first contact member extends along a circumferential direction and has a first gap between first both ends of the first contact member in the circumferential direction;
the second contact member extends along the circumferential direction and has a second gap between second both ends of the second contact member in the circumferential direction; and
a position of the first gap between the first both ends of the first contact member is different from a position of the second gap between the second both ends of the second contact member in the circumferential direction.

9. The terminal connection structure according to claim 1, wherein:
the female terminal has a columnar portion provided upright from a bottom face of the female terminal;
the male terminal has a hole portion that receives the columnar portion of the female terminal;
the second face of the female terminal is an outer face of the columnar portion; and
the first face of the male terminal is an inner face of the hole portion facing the outer face of the columnar portion.

10. The terminal connection structure according to claim 9, further comprising a third contact member interposed between the male terminal and the female terminal, the third contact member electrically connecting the male terminal to the female terminal, wherein:
the third contact member is disposed between a distal end face of the male terminal and the bottom face of the female terminal, the bottom face of the female terminal facing the distal end face of the male terminal; and
the third contact member is configured to elastically deform in a third direction in which the distal end face of the male terminal and the bottom face of the female terminal face each other; and
the second direction is the radial direction.

11. The terminal connection structure according to claim 3, wherein:
the first contact member is in contact with the inner face of the female terminal at the upper end portion and the lower end portion; and
the first contact member is in contact with the outer face of the male terminal at an intermediate part of each of the elastic pieces.

12. The terminal connection structure according to claim 10, wherein the third direction is an axial direction parallel to an insertion direction of the male terminal to the female terminal.

13. The terminal connection structure according to claim 1, wherein:
the first face of the male terminal is a distal end face of the male terminal; and
the second face of the female terminal is a bottom face of the female terminal, the bottom face of the female terminal facing the distal end face of the male terminal.

14. The terminal connection structure according to claim 13, wherein the second direction is an axial direction parallel to an insertion direction of the male terminal to the female terminal.

15. The terminal connection structure according to claim 6, wherein:
the second contact member is in contact with the second face of the female terminal at the first end portion and the second end portion; and
the second contact member is in contact with the first face of the male terminal at an intermediate part of each of the elastic pieces.
